(19) United States
(12) Patent Application Publication
(10) Pub. No.: US 2010/0058168 A1
(43) Pub. Date: Mar. 4, 2010

(54) MULTIPLE VIEWS FOR WEB APPLICATIONS ACROSS MULTIPLE ENDPOINTS

(75) Inventors: Erik Gibb, San Francisco, CA (US); Cody Simms, Los Angeles, CA (US); Matthew J. Kozlov, Santa Monica, CA (US); Micah Laaker, Mountain View, CA (US); Nicole Gregory, San Francisco, CA (US); Isaac Z. Schlueter, Santa Clara, CA (US); Naitik Shah, Mountain View, CA (US); Sadaf Shahsahebi, Sunnyvale, CA (US); Steven Spencer, Northridge, CA (US)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo! Inc., Sunnyvale, CA (US)

(21) Appl. No.: 12/200,545

(22) Filed: Aug. 28, 2008

(51) Int. Cl. G06F 17/00

(52) U.S. Cl. 715/234

(57) ABSTRACT

In one example embodiment, a selection may be received from a user of one of a plurality of web applications. Information related to one or more views of the selected application may be assembled and transmitted to a user computing platform for display in a plurality of application areas for a respective plurality of web pages associated with the user.

This patent application is being concurrently filed with U.S. patent application Ser. No. ______, titled “Embeddable Web Application Agent,” filed on Aug. __, 2008, by Engel (attorney docket no. 070.P044); and U.S. patent application Ser. No. ______, titled “Contextually Aware Web Application,” filed on Aug. __, 2008, by Engel (attorney docket no. 070.P052); both of which are assigned to the assignee of currently claimed subject matter and incorporated by reference in their entirety.

### FIELD

Subject matter disclosed herein may relate to a web application execution platform, and more particularly to multiple views for web applications that may be accessed across multiple web entities.

### BACKGROUND

With networks such as the Internet gaining tremendous popularity, and with the vast multitude of pages and/or other documents and/or other media content becoming available to users via the World Wide Web (web), it has become desirable for some web page publishers and/or other entities related to the web to implement application execution environments to allow users to run applications via the entity's web site, and to entice users to visit the sites. Such application execution environments may comprise “stand alone” environments, with the web page publisher performing page assembly as well as performing back-end integration with data storage, social information, etc.

### BRIEF DESCRIPTION OF THE FIGURES

Claimed subject matter is particularly pointed out and distinctly claimed in the concluding portion of the specification. However, both as to organization and/or method of operation, together with objects, features, and/or advantages thereof, it may best be understood by reference to the following detailed description when read with the accompanying drawings in which:

FIG. 1 is an illustration depicting an example embodiment of an application platform;

FIG. 2 is an illustration depicting an example web page;

FIG. 3 is a flow diagram of an example embodiment of a method for supporting multiple views for web application;

FIG. 4 is a block diagram of an example system comprising an application platform, a web page publisher, and a user computing platform;

FIG. 5 is a block diagram of an example embodiment of an application platform;

FIG. 6 is a block diagram depicting application programming interfaces related to a web application platform; and

FIG. 7 is a block diagram illustrating an example system comprising a plurality of computing devices coupled via a network in accordance with one or more embodiments.

Reference is made in the following detailed description to the accompanying drawings, which form a part hereof, wherein like numerals may designate like parts throughout to indicate corresponding or analogous elements. It will be appreciated that for simplicity and/or clarity of illustration, elements illustrated in the figures have not necessarily been drawn to scale. For example, the dimensions of some of the elements may be exaggerated relative to other elements for clarity. Further, it is to be understood that other embodiments may be utilized and structural and/or logical changes may be made without departing from the scope of claimed subject matter. It should also be noted that directions and references, for example, up, down, top, bottom, and so on, may be used to facilitate the discussion of the drawings and are not intended to restrict the application of claimed subject matter. Therefore, the following detailed description is not to be taken in a limiting sense and the scope of claimed subject matter defined by the appended claims and their equivalents.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

Reference throughout this specification to “one embodiment” or “an embodiment” means that a particular feature, structure, or characteristic described in connection with the embodiment is included in at least one embodiment of claimed subject matter. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

The term “and/or” as referred to herein may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

As discussed above, it may be desirable for web page publishers and/or other entities related to the web to implement application execution environments to allow users to run applications via the entity's web site, and to entice users to visit particular web sites. Web application developers may produce applications to operate within the web application execution environments. Applications may be developed for a particular web page, or a particular type of web page. If the application developer desires to have the web application accessible via other web pages and/or web sites, different versions of the application may be generated and provided to the application execution environments. Different web sites and/or application execution environments may have varying requirements for the development of web applications, prompting the application developer to modify applications for use on those sites and/or execution environments. Thus, web application developers may incur additional effort and/or expense in porting applications across multiple web sites.

Users desiring to take advantage of web applications may search a number of web sites to locate desired applications. If a user wishes to utilize the multiple applications from the different sites, the user may browse to those particular web sites associated with those particular applications. The user's experience at the different sites may vary from site to site and/or from page to page, and the user may further need to maintain separate user accounts at the different sites in at least some cases. It may therefore be inconvenient and/or inefficient for a user to utilize web applications emanating from disparate sites and/or pages, thus diminishing the user's incentive to visit the sites hosting the applications.

In an example embodiment, a web application platform may receive one or more code segments associated with a web application from a web application developer, for example, and may generate multiple views of the application to be displayed across multiple web sites and/or web pages. The web developer, for an example embodiment, may avoid generating customized code for the various web sites and/or pages, thus reducing the effort and/or expense of developing the application. Further, the application platform may provide users with different views of the application to suit various circumstances, for another example. Further, in an example embodiment, users may access the developed web application from a number of sites and/or pages, and the web application platform may track information related to the user such as, for example, which application or applications the user has “installed” or selected, as well as perhaps other information related to the user. In one or more embodiments, the web application platform may track for the user information related to any of a number of possible options that may be provided related to a web application. In this manner, the web application platform may provide the user with appropriate applications using appropriate options at a number of web sites and/or pages and with a number of views, if desired. Of course, these are merely examples of the types of operations that may be supported by a web application platform in accordance with claimed subject matter, and the scope of claimed subject matter is not limited in these respects.

As used herein, the term “endpoint” is meant to include any network location through which a user may access information. A network may include, for example, the Internet, and network locations may include, but are not limited to, web sites and/or web pages. In an embodiment, an endpoint may comprise a web site, and in other embodiments an endpoint may comprise at least a portion of a web site. For example, a web site may include one or more pages associated with a sports theme, and may also include one or more pages associated with a movies theme. The one or more sports pages may comprise one or more endpoints, and the one or more movie pages may comprise one or more additional endpoints. For another example, an endpoint may comprise a profile page for a user, and/or may comprise a personalized start page for the user. Additionally, endpoints may comprise mobile and/or handheld devices, such as, for example, cellular telephones. Of course, these are merely example endpoints, and the scope of claimed subject matter is not limited in this respect.

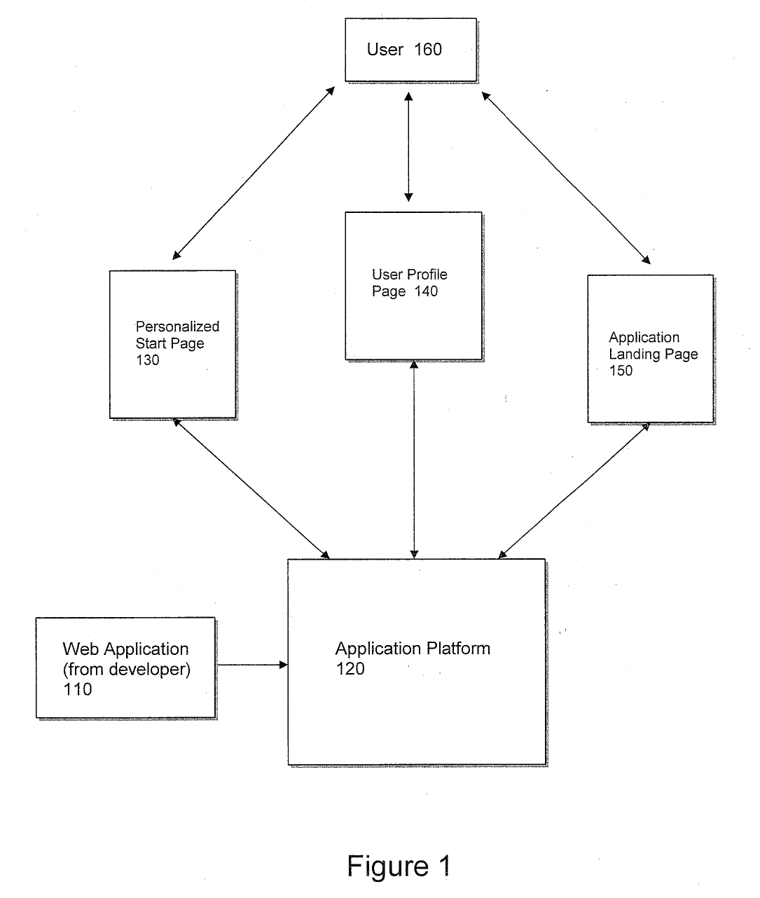

FIG. 1 is an illustration depicting an example embodiment of an application platform 120. A web application developer may, for an example, develop a web application 110, and may desire to allow a user 160 to access the developed application 110 from any of a number of different web sites and/or pages. For the example embodiment of FIG. 1, such web pages and/or sites may include a personalized start page 130, a user profile page 140, and/or an application landing page 150.

Application landing page 150 for embodiments described herein may comprise a web page dedicated to one or more web applications, such as application 110. If user 160 desires to utilized application 110, user 160 may browse to landing page 150, and an interface may be provided to user 160 to enable the user to interact with web application 110. Application landing page 150 may provide one or more views of web application 110. Example web application views are described below.

Personalized start page 130 may comprise, for one or more embodiments, customized content for user 160. Personalized start page 130 may automatically be loaded by a browser executed on a user computing platform upon starting the browser application, in an example embodiment. Personalized start page 130 for an example embodiment may only be accessed by user 160, and other users may not be allowed access to the page. Personalized start page 130 may be customized by,user 160 in any of a number of aspects. User 160 may be provided with a number of options for customizing the content and/or appearance of the page, for example. User 160 may desire to have news headlines displayed, may desire to have current local weather displayed, and/or may desire to have results from particular sports teams displayed, to name but a few examples of possible customized content. User 160 may specify a particular color scheme for the personalized start page, for another example. Of course, these are merely examples of ways in which a personalized start page may be customized, and the scope of claimed subject matter is not limited in this respect. Further, for an embodiment, personalized start page 130 may include an option to support web applications, such as web application 110, and one or more views of application 110 may be supported.

User profile page 140 may comprise be utilized to store information related to user 160, for this example embodiment. Information such as names, identifiers, email addresses, biographical information, interests, hobbies, etc., to name but a few types of information that may be maintained in a personal profile page. For one or more embodiments, user profile page 140 may also include one or more friends lists containing names or identifiers of individuals and/or groups of individuals associated with user 160. Further, for an embodiment, profile page 140 may support web applications such as application 110, and one or more views of application 110 may be supported. Also for one or more embodiments, public, shared, and/or private information supplied by user 160 to user profile page 140 may be accessed by web application 110, thereby providing the web application with a source of user information and/or social connections. User 160 may be provided an option, for an example embodiment, to not share private information, and/or to not share particular pieces of private information.

As depicted in FIG. 1, and as described above, web application 110 for this example embodiment may be accessed by user 160 in any of several ways. For example, web application 110 may be accessed via a number of endpoints. Endpoints for this example may include application landing page 150, user profile page 140, and/or personalized start page 130. For an embodiment, a web developer may be provided with one or more application programming interfaces (API), discussed more fully below, that may permit the developer to specify a web application that can be automatically made available to user 160 without requiring the web developer to produce different code for the different endpoints. Rather, application platform 120 may receive code from the web developer for application 110 and may provide support for application 110 for each of the different endpoints. Multiple views of web application 110 may also be supported at the different endpoints.

In an embodiment, user 160 may install an application such as web application 110 using a number of techniques. For an example, if user 160 is visiting one of the endpoints supported by application platform 110, user 160 may make a selection from a pull-down menu, a hypertext link, and/or other form of a “call to action” that may cause an area to be opened, and/or a pre-existing area to be revealed, as predetermined by the endpoint in one example, on the displayed page. Such an area may be referred to as a “dropzone”, as discussed more fully below, although the scope of claimed subject matter is not limited in this respect. A dropzone may comprise, for an example, an area of a web page in which web applications may be displayed. For an example embodiment, if user 160 makes a selection that causes the dropzone to appear, an “application gallery” may also be displayed. The application gallery for an example embodiment may be displayed approximately adjacent to the dropzone, and/or may be displayed within the dropzone, although the scope of claimed subject matter is not limited in this respect. The application gallery, for an embodiment, may provide user 160 with a number of web applications from which the user may choose. The application gallery may comprise information related to the various available web applications, including such information, for example, as application names, descriptions of the applications, one or more categories for the applications, the number of other installations of the various applications, profile information for web application developers, icons for the applications, and/or screenshots of one or more of the applications. Further types of information that may be provided to user 160 may include, but are not limited to, statistics regarding popularity of one or more applications, perhaps both among the user's friends and the larger public, ranking information for one or more applications, perhaps provided by third-party testers, for example, reviews of one or more applications by journalists and/or users, and/or the developer's terms of service. At least portions of such information may be provided to application platform 120 by the web application developer, and such information may be offered in the form of metadata associated with the developed web application. Of course, these are merely examples of the types of information that may be included in an application gallery, and the scope of claimed subject matter is not limited in this respect.

For an embodiment, through the application gallery, a user may browse applications by application name, category, ratings/rankings, developer name, tags, and/or other information provided by the application gallery. Further, a user may, for some embodiments, browse friend's applications, as well as applications the user may have installed and/or otherwise accessed at other endpoints. A user may select an application for an example embodiment by “clicking” on an icon associated with the application using a mouse and/or other pointing device, although the scope of claimed subject matter is not limited in this respect.

For an embodiment, upon receiving the selection from the user, the selected application, such as web application 110 for the current example, may be opened in the dropzone. For one or more embodiments, user 160 may test or “demo” the application for a period of time before permission may be granted for the application platform to access user personal and/or social data and/or the user may be asked to grant any requested permission before the application can be installed. At the conclusion of the test period, or whenever user 160 may instruct, the gallery may be closed, and the selected web application may be added to the user's profile. As such, the application may be made available to the user from any of the endpoints associated with application platform 120.

In an embodiment, the selected application may be stored in an application bin on the user's profile page and/or at one or more additional endpoints. The application bin may show, for example, an application's name and/or icon and/or other representation of the entire functionality of the application. For one or more embodiments, if the user clicks on the name and/or icon and/or other representation of the entire functionality of the application, the application may be opened or revealed, if already running but hidden in an embodiment, in a full view, described below, on the application's landing page and/or in the context of the endpoint, although the scope of claimed subject matter is not limited in these respects.

For one or more embodiments, endpoints may be maintained by the same entity as application platform 120, although in one or more other embodiments, one or more endpoints may be maintained by third-party web page publishers, as is discussed more fully below. For third-party web page publishers, a gallery API may be provided to enable the third-party developer to generate an application gallery, thereby enabling the third-party publisher to import applications supported by application platform 120 and further enabling user 160 to browse and select web applications associated with application platform 120 from an endpoint not directly maintained by the application platform.

For an embodiment, user 160 may be permitted to view at least a portion of a profile of another user. For example, a second user may designate user 160 as a “friend” in the second user's profile, and the second user may grant user 160 permission to view some or all of the information maintained in the second user's profile. The second user's profile, for an example, may contain a listing of web applications associated with the second user. User 160 may desire to know which application his/her friend has found to be of interest and/or useful, and may browse the second user's application list for possible applications to install. User 160 may select, perhaps by way of a “click” using a pointing device, an application of interest from the second user's list, and that application may then become associated with user 160, and user 160 may access the newly-added application from any of the endpoints associated with application platform 120 for which user 160 has access. In an embodiment, if user 160 installs an application from the second user's profile page, user 160 may be directed to his/her own profile page with the newly added application showing.

Another possible technique for a user such as user 160 to select an application is to browse to a landing page for a particular application such as, for the present example, application landing page 150 dedicated to web application 110 for this example. At the landing page, user 160 may click or otherwise select an “install” option, perhaps presented to the user in the form of an icon on page 150. As used herein, the term “install” as it refers to a web application is meant to denote associating the web application with a particular user. For example, if a web application is installed, it may be stored in a list of applications as part of the user's profile, and the web application may be made available to the user by way of a menu or some other technique at one or more endpoints associated with the user. User 160 may be directed to landing page 150 by any of a variety of ways, including, for example, performing a search using a search engine. For another example, user 160 may receive an email or some other type of message from another user recommending the application and providing the location of the page or perhaps a hyperlink to the page. In one or more embodiments, if a user installs an application to his/her profile, a notification may be delivered to one or more of the user's friends, and the friends may make a determination whether to also install the application.

In the example techniques described above enabling a user to locate and install a web application, note that a single installation may result in the web application being installed at multiple endpoints, thus enhancing the user's web experience and perhaps enhancing the user's attraction to endpoints associated with application platform 120, thereby encouraging the user to visit the endpoints more frequently. Further, the mechanisms described herein for sharing information with lists of friends may result in additional users being motivated to visit endpoints associated with application platform 120. In addition, as described above, a web application developer may develop an application, and that application may be made available to users via multiple endpoints by application platform 120. Further, as is described more fully below, multiple views for an application may be made available to users across multiple endpoints.

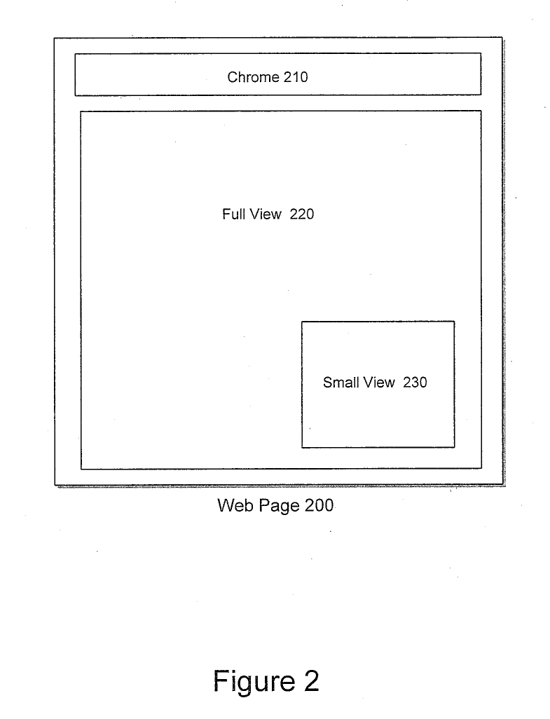

FIG. 2 is an illustration depicting an example web page 200. Web page 200 for this example may represent any of a number of possible endpoints that may be associated with an application platform such as, for example, application platform 120, discussed above. For one example, web page 200 may comprise an application landing page. For other examples, web page 200 may comprise a user profile page and/or a personalized start page associated with a user. Of course, these are merely example types of web pages, and the scope of claimed subject matter is not limited in this respect. For the present example, web page 200 may comprise a chrome area 210. As used herein, the term “chrome” refers to an application's visual container and/or management menu structure, and may also apply to dropzones in which the application may be displayed.

For an embodiment, the chrome 210 menu structure may include elements that may enable relatively intuitive and/or simple interactions for a user. For one or more embodiments, chrome 210 menu elements may include, but are not limited to: notification settings that may control how an application may communicate with a user and the user's social connections; settings to determine a type of view in which to display the application; controls for sharing the application, such as controls for emailing the application to other users; controls to manage the applications settings and user preferences; additional information provided by metadata describing aspects of the application; and/or controls to remove the user's installation of the application should the user decide to do so. Of course, these are merely examples of controls and information that may be provided in a menu structure for an application as part of chrome 210, and the scope of claimed subject matter is not limited in this respect.

Web page 200, for this example, may further include multiple views in which a web application and/or dropzone may operate. For example, a user may have an option to select a full view 220, and/or may have an option to select a small view 230, as illustrated for example purposed in FIG. 2. For an embodiment, full view 220 may provide a more rich “canvas” than may be possible with a smaller view. A full view such as full view 220 may be utilized in an application landing page, for an embodiment. Full view 220 may provide relatively large real-estate for application execution. For example, full view 220 may have a width of 646 pixels, and the height of the full view may be unrestrained, in one or more embodiments, although the scope of claimed subject matter is not limited in this respect. Also for one or more embodiments, an application's full view may be accessed from the application's chrome menu if the application is in small view. Full view 220 may further be automatically accessed by browsing to an application's landing page, for example. For one or more embodiments, an application's full view may be composed on hypertext markup language (HTML), extensible markup language (XML), javascript (JS), secure hypertext processor (PHP), extensible stylesheet language (XSL), etc., to name but a few languages that may be used to implement the views and/or other elements described herein. However, these are merely examples of languages that may be utilized to implement views and/or other elements described herein, and the scope of claimed subject matter is not limited in these respects. Further, for one or more example embodiments, full view 220 may support advertising and/or promotions. Such advertising and/or promotions may comprise third-party advertisements and/or promotions, and may be supplied, in some embodiments, by application developers, although the scope of claimed subject matter is not limited in this respect.

For one or more embodiments, small view 230 may represent a module within a larger web page framework. Small view 230 may be considered, in some circumstances, as a “teaser” view that may be used to entice a user to utilize a larger view, such as full view 220. For one or more embodiments, any of a number of possible endpoints may support small views. For an embodiment, endpoints that may support small views may include, but are not limited to, user profile pages and/or personalized startup pages. Also for an embodiment, the dimensions for small view 230 may comprise a width of approximately 300 pixels, although of course the scope of claimed subject matter is not limited in this respect. For one or more embodiments, the height of the small view may comprise approximately 250 pixels, although again, the scope of claimed subject matter is not limited in this respect. Small view 230 may be utilized in situations where an application's real estate is constrained for whatever reason. For one or more embodiments, information reflected in a small view such as small view 230 may reflect information that may be most appealing and/or informative to the user and that may entice the user to engage the full view of the application. Such information may be determined by the application developer. For one or more embodiments, advertising and/or promotions may not be supported in small view, although the scope of claimed subject matter is not limited in this respect.

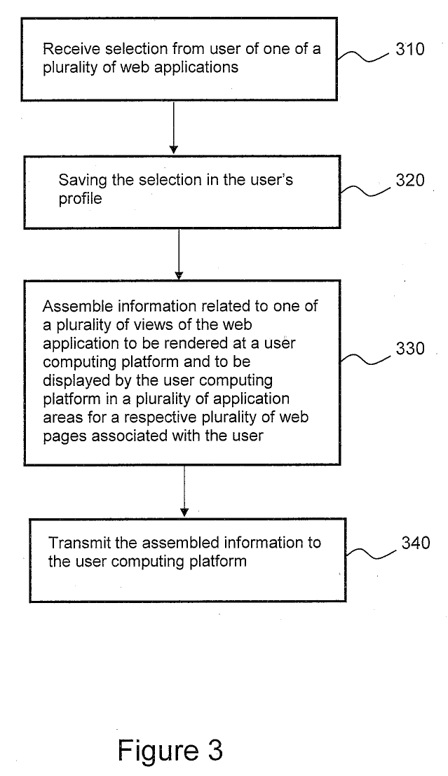

FIG. 3 is a flow diagram of an example embodiment of a method for supporting multiple views for web application. At block 310, a selection may be received from a user wherein the user selects one of a plurality of web applications. As described above, for one or more embodiments, the user may browse an application gallery and may select an application from the gallery, although the scope of claimed subject matter is not limited in this respect. At block 320, the user's selection may be saved in the user's profile and/or at one or more other specified endpoints. In one or more embodiments, the application may be stored in an application bin, as described above, although again, the scope of claimed subject matter is not limited in this respect.

At block 330, information may be assembled, wherein the information may be related to one of a plurality of views of the web application to be rendered at a user computing platform and to be displayed by the user computing platform in a plurality of application areas for a respective plurality of web pages associated with the user. For an embodiment, the plurality of web pages associated with the user may comprise one or more of a personalized start-up page, a user profile page, and/or an application landing page. Also, the application area may comprise a dropzone, as described herein. However, these are merely examples of web pages that may be associated with a user and of application areas for those web pages, and the scope of claimed subject matter is not limited in these respects.

At block 340, the assembled information may be transmitted to the user computing platform. For one or more embodiments, the assembled information may comprise assembled page data, as described more fully below. Embodiments in accordance with claimed subject matter may include more than, less than, or all of blocks 310-340. Also, the order of blocks 310-340 is merely an example order, and the scope of claimed subject matter is not limited in this respect.

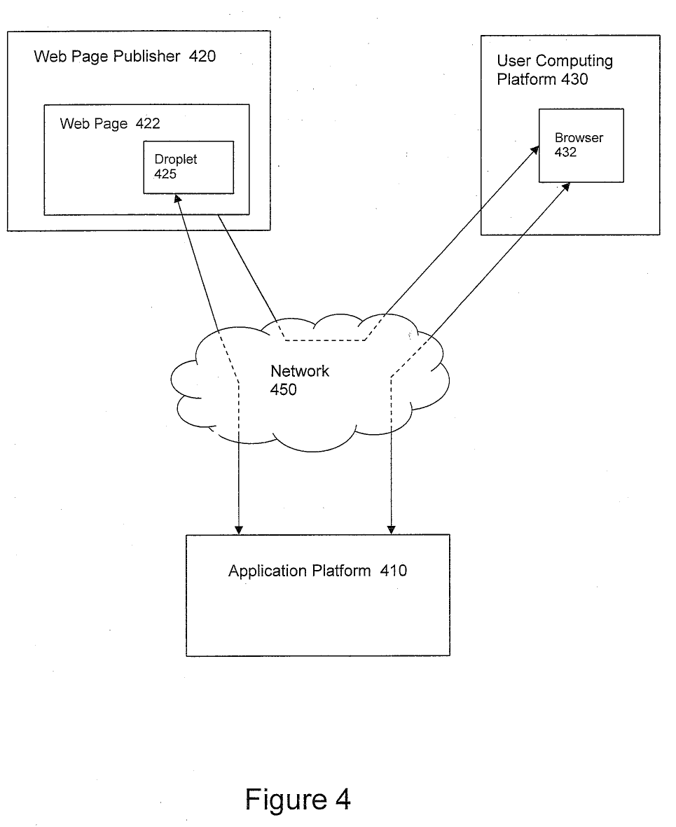

FIG. 4 is a block diagram of an example system comprising an application platform 410, a web page publisher 420, and a user computing platform 430. In an example embodiment, an application execution environment may be divided among application platform 410, web page publisher 420, and user computing platform 430. For this example embodiment, a code segment may be provided to a web page publisher by an application platform. The code segment may be embedded in a web page generated by the web page publisher, and the user computing platform may execute the code segment at least in part in response to loading the web page. Further, for this example embodiment, a request for information related to one or more web applications may be received by the application platform from the user computing platform. The user computing platform may make the request at least in part in response to executing the code segment. The application platform may provide information related to the one or more web applications to the user computing platform.

In this example embodiment, application platform 410 may provide so-called “back-end” services such as data storage, application development, and/or page assembly, as well as provide social back-end database information, for just a few examples of services that may be provided. Thus, web site publisher 420 may be relieved of the burden of directly providing these services, and the cost and/or overhead of developing and/or maintaining the application execution environment may be reduced. For this example embodiment, web page publisher 420 may represent a third-party publisher, mentioned above. In other embodiments, web page publisher 420 may not be a third-party publisher, but may rather be part of the same entity as application platform 410. For example, a web site may publish web pages, and may also maintain an application platform in accordance with embodiments described herein. Thus, although FIG. 4 depicts web page publisher 420 and application platform 410 as separate entities, other embodiments are possible where web page publisher 420 and application platform 410 comprise a single entity.

Application platform 410, web page publisher 420, and user computing platform 430 for this example may be coupled to each other by way of a network 450. For this example embodiment, network 450 may comprise the Internet, although the scope of claimed subject matter is not limited in this respect. The web is an Internet service that organizes information through the use of hypermedia. HTML is typically used to specify the contents and format of a hypermedia document (e.g., a web page). XML may also be used to specify the contents and format of a web page. As used herein, a web site may refer to a collection of related web pages. The term “web page” as used herein may relate to any electronic document that may be accessed via a network such as the Internet. As alluded to above, in one or more embodiments, web pages for an example embodiment may comprise documents coded using one or more markup languages, such as, for example, HTML and/or XML, although the scope of claimed subject matter is not limited in this respect.

User computing platform 430 for this example embodiment may comprise a processor (not shown) that may execute instructions, including executing instructions related to a web browser 432. Web browser 432 for this example may comprise a conventional web browser to be executed by user computing platform 430 to allow a user to access and view web pages from across the Internet, including pages published by web page publisher 420. To view a page published by web page publisher 420, browser 432 may cause the page to be downloaded from web page publisher 420 to user computing platform 430, where the page may be displayed to the user. A web page may be identified by a Uniform Resource Identifier (URI) such as, for example, a Uniform Resource Locator (URL) associated with the web page.

For this example embodiment, web page publisher 420 may desire to implement an application execution environment on a web page. For example, web page publisher 420 may desire to provide a game application for use by one or more users across the Internet in the hopes that the game application may entice users to visit a web site. Application platform 410 may have stored thereon instructions implementing the desired application, and may further comprise a code segment associated with the desired application. Application platform 410 may transmit the code segment to web page publisher 420. For this example, the code segment may comprise instructions related to the application, which, for this example, may comprise the game application, although the scope of claimed subject matter is not limited in this respect. For an embodiment, the code segment may comprise Javascript instructions to implement the application. Javascript is a scripting language that may be embedded in an electronic document, such as, for example, an HTML based document. Although the example embodiments described herein utilize Javascript to implement applications, Javascript is merely an example of type of code that may be used to implement an application, and the scope of claimed subject matter is not limited in this respect. For example, for one or more additional embodiments, the code segment may comprise code implemented in PHP such as, for example, PHP release 5.2.6, although the scope of claimed subject matter is not limited in this respect. PHP is another example of a scripting language that may be embedded into an electronic document, such as an HTML document, for example, although the scope of claimed subject matter is not limited in this respect.

For one or more embodiments, the code segment may be embedded in one or more web pages by web page publisher 420. One such web page is labeled page 422 in FIG. 4. Web page 422 may include an area on the page on which an application may be run. The application area may be referred to as a “dropzone”, mentioned above, in one or more embodiments, although the scope of claimed subject matter is not limited in this respect. Further, the code segment may be referred to as a “droplet”, such as, for example, droplet 425 of FIG. 4, and may comprise instructions related to the application as well as instructions that may be utilized to implement the application execution area (dropzone) on web page 422. As used herein, the term “code segment” is meant to include one or more instructions used to implement an application execution area in an electronic document, such as, for example a web page. Also, as used herein, the terms “code segment” and “droplet” are interchangeable.

User computing platform 430 may, via browser 432, request the aforementioned web page 422 with the embedded droplet 425 from web page publisher 420. At least in part in response to receiving web page 422, browser 432 may execute the embedded code segment. The code segment may include instructions that may direct user computing platform 430 to communicate with application platform 410, for an example embodiment. For example, the execution of droplet 425 may direct user computing platform 430 to request information related to the application from application platform 410. Application platform 410 may, at least in part in response to receiving the request, provide the information to user computing platform 430, which may in turn utilize the information in the execution of the droplet. The information related to the application may comprise any of a wide range of information types, including, but not limited to, social backend information, user profile information, assembled pages, executable code, application configuration information, information related to the “look and feel” of the application, etc.

As described above, a droplet may be associated with one or more applications. For one embodiment, the droplet may direct user computing platform 430 to communicate with application platform 410 in order to implement the one or more applications. Thus, web page publisher 420 may provide the one or more applications to user computing platform 430, but does not incur the overhead of providing application services, such as data storage/transfer and application execution, as these services are provided by application platform 410. For one or more embodiments, droplet 425 may comprise relatively few instructions, perhaps merely one or a few lines of code in some examples, and the bulk of the application processing responsibilities may be performed by application platform 410. In this manner, web page publisher 420 may distribute an application such as the application associated with droplet 425 with relative ease, due to the relatively small size of the droplet. Further, the small size of the droplet may allow an application developer to widely disseminate the application to a wide range of web page publishers, if desired. Web page publishers may be enticed to include the application in their web pages because of the relatively low overhead associated with embedding the code segment, and because the “heavy lifting” of the application execution and/or data transfer/storage associated with the application is handled by application platform 410.

As described above, a user may, for one or more embodiments, access a web application from more than one web page. Thus, application platform 410 may distribute droplet 425 to more than one web page publisher, or for another embodiment web page publisher 420 may include droplet 425 in more than one web page. Browser 432 may access the web application associated with droplet 425 from any of the web pages embedding droplet 425, provided that the user has sufficient permissions to access the web application. Application platform 410 may maintain a user profile for the user that may include an application bin for the user, as described above. Thus, application platform 410 may maintain permissions for various applications for the user. For an embodiment, web page publisher 420 may publish a landing page for the application, and/or may publish a personalized start-up page for the user. For one embodiment, a user profile page may be published and/or maintained by application platform 410. Of course, these are merely examples of how user information and/or permissions may be managed, and the scope of claimed subject matter is not limited in this respect.

For one or more embodiments, the application associated with droplet 425 may be largely executed by application platform 410, with relatively little processing performed by user computing platform 430. For one example embodiment, application platform 410 may receive keystroke and/or pointing device information from user computing platform 430, and in response may assemble appropriate pages of javascript code to be executed by browser 432. Compute-intensive operations may be performed by application platform 410, thereby relieving user computing platform 430 of much of the burden of executing the application, for an example embodiment. Browser 432 for this example may receive the assembled pages of javascript code and may run the code using a javascript interpreter coupled with browser 432. The application may be displayed by browser 432 in the web page's dropzone. Thus, the overhead incurred by user computing platform 430 in executing the application is relatively small. Further, because web page publisher 420 is not involved in the transfer of the assembled javascript pages, web page publisher 420 may not incur a load other than initially delivering web page 422 including droplet 425 to user computing platform 430.

For one or more other embodiments, user computing platform 430 may be more involved in the execution of the application than was the case in the previous example embodiments. The droplet and its associated application may be architected in a manner to allocate execution responsibilities in anyway that may be advantageous.

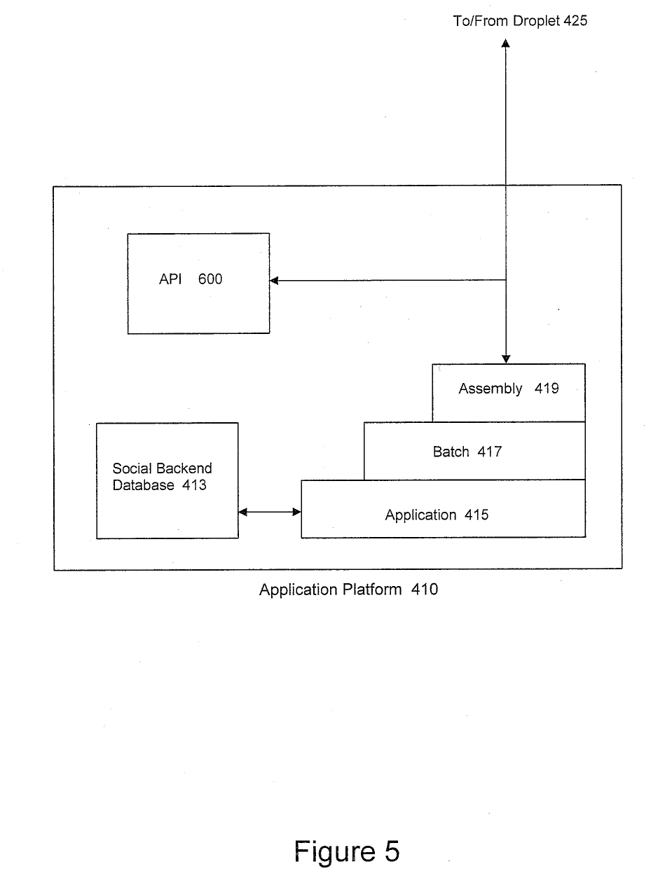

FIG. 5 is a block diagram of an example embodiment of application platform 410, shown in more detail. Application platform 410 may comprise a computing platform including one or more processors (not shown). Application platform 410 may comprise a social backend database 413 that may store social information that may be used in connection with one or more applications. Social information may comprise any of a wide range of information types. Some examples of social information may include, but are not limited to, user profile information, friends lists for a number of users, game scores and/or progress information, lists of visited web sites, information regarding user browsing behaviors, information regarding user's interests, etc. Of course, these are merely examples of social information, and the scope of claimed subject matter is not limited in this regard.

Application platform 410 may execute instructions that may implement an API 600, as well as a software stack comprising an application layer 415, a batch layer 417, and an assembly layer 419. Application layer 415 may comprise instructions that, if executed, direct application platform 410 to generate one or more applications. Any of a wide range of application types may be implemented. Examples of application types that may be implemented may include, but are not limited to, fantasy sports games, word processors, spreadsheet calculators, card games, board games, financial applications, musical composition and notation, educational applications, language study applications, etc., to name but a few. Of course, these are merely examples of application types, and the scope of claimed subject matter is not limited in these respects.

Batch layer 417 may comprise instructions that, if executed, may batch together one or more applications provided by application layer 415. Assembly layer 419 may comprise instructions that, if executed, direct application platform 410 to assemble one or more pages of code according to the batched one or more applications for delivery to user computing platform 430. For this example, the pages of code may comprise javascript code, although the scope of claimed subject matter is not limited in this respect.

Further for this example embodiment, web page publisher 420 may communicate with application platform 410 by way of API 600, described in more detail below. Communications may take place through droplet 425, for this example embodiment. That is, droplet 425 may include code that if executed may provide programming hooks for web publisher 420 in order for web publisher 420 to make a variety of requests of application platform 410.

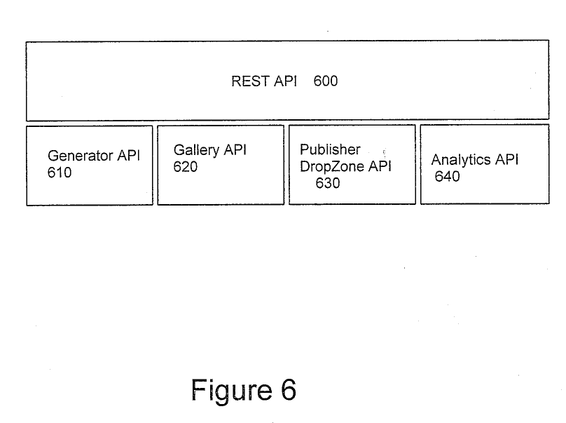

FIG. 6 is a diagram illustrating an example embodiment of API 600. For one or more embodiments, the APIs described herein may comprise “restful” APIs. A “restful” API may refer to any relatively simple interface which may transmit domain-specific data over hypertext transfer protocol (HTTP) without an additional messaging layer, for one example embodiment. Restful APIs may be characterized, at least in part, by their simplicity. Of course, a restful API is merely an example, and the scope of claimed subject matter is not limited in this respect. For this example embodiment, API 600 may comprise several sub-APIs. For example, API 600 may comprise a generator API 610, a gallery API 620, a publisher dropzone API 630, and an analytics API 640. In an embodiment, generator API 610 may comprise an API through which web publisher 620 may request one or more applications to be included in its dropzone. Gallery API 620 for an embodiment may comprise a read-only API through which web publisher 620 may receive information regarding which applications are to be included in the dropzone for a particular web site. Also, publisher dropzone API 630 for this example may comprise an API through which web publisher 420 may specify various aspects of its dropzone including, but not limited to, specific applications to be included in the dropzone as well as customization parameters. The customization parameters for this example may comprise parameters that specify the “look and feel” of a web page's dropzone. The look and feel aspects of a dropzone may include a presentation layer that may comprise a skin as well as a menu system, which, for an embodiment may be referred to as a “chrome” architecture, described above. API 600 may also comprise an analytics API 640 through which web publisher 620 may request various statistics regarding a dropzone. For example, web publisher 420 may request information related to the performance of one or more applications, as well as information regarding which is the more popular application among a number of applications, to name just a couple of examples. Of course, other types of information may be made available through the analytics API in one or more embodiments.

It should be noted that for one or more embodiments, web publisher 420 may access API 600 through droplet 425, and that for one or more embodiments there may be no other paths through which web publisher 420 may access API 600. For one or more embodiments where web publisher 420 comprises the same entity as application platform 410, other paths of communication may be provided between the web publisher and the application platform. Further, for one or more embodiments, API 600 may comprise a programming interface through which a web application developer may specify a web application that may be represented in multiple views across multiple endpoints, as described previously.

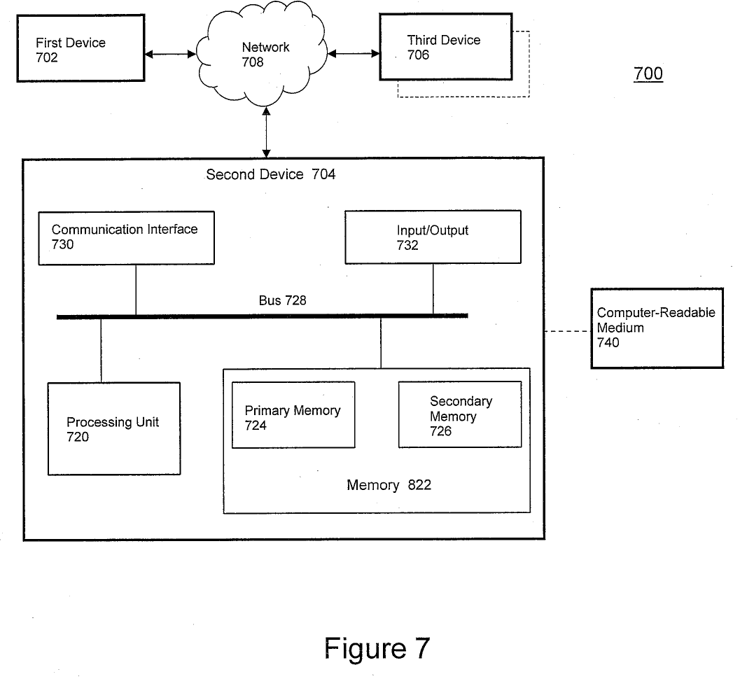

FIG. 7 is a schematic diagram illustrating an exemplary embodiment of a computing environment system 700 that may include one or more devices configurable to implement techniques and/or processes described above in connection with dropzones and/or droplets and/or web applications discussed above in connection with FIGS. 1-6, for example. System 700 may include, for example, a first device 702, a second device 704, and a third device 706, which may be operatively coupled together through a network 708.

First device 702, second device 704 and third device 706, as shown in FIG. 7, may be representative of any device, appliance or machine that may be configurable to exchange data over network 708. By way of example but not limitation, any of first device 702, second device 704, or third device 706 may include: one or more computing devices and/or platforms, such as, e.g., a desktop computer, a laptop computer, a workstation, a server device, or the like; one or more personal computing or communication devices or appliances, such as, e.g., a personal digital assistant, mobile communication device, or the like; a computing system and/or associated service provider capability, such as, e.g., a database or data storage service provider/system, a network service provider/system, an Internet or intranet service provider/system, a portal and/or search engine service provider/system, a wireless communication service provider/system; and/or any combination thereof.

Similarly, network 708, as shown in FIG. 7, is representative of one or more communication links, processes, and/or resources configurable to support the exchange of data between at least two of first device 702, second device 704, and third device 706. By way of example but not limitation, network 708 may include wireless and/or wired communication links, telephone or telecommunications systems, data buses or channels, optical fibers, terrestrial or satellite resources, local area networks, wide area networks, intranets, the Internet, routers or switches, and the like, or any combination thereof. As illustrated, for example, by the dashed lined box illustrated as being partially obscured of third device 706, there may be additional like devices operatively coupled to network 708.

It is recognized that all or part of the various devices and networks shown in system 700, and the processes and methods as further described herein, may be implemented using or otherwise include hardware, firmware, software, or any combination thereof.

Thus, by way of example but not limitation, second device 704 may include at least one processing unit 720 that is operatively coupled to a memory 722 through a bus 728.

Processing unit 720 is representative of one or more circuits configurable to perform at least a portion of a data computing procedure or process. By way of example but not limitation, processing unit 720 may include one or more processors, controllers, microprocessors, microcontrollers, application specific integrated circuits, digital signal processors, programmable logic devices, field programmable gate arrays, and the like, or any combination thereof.

Memory 722 is representative of any data storage mechanism. Memory 722 may include, for example, a primary memory 724 and/or a secondary memory 726. Primary memory 724 may include, for example, a random access memory, read only memory, etc. While illustrated in this example as being separate from processing unit 720, it should be understood that all or part of primary memory 724 may be provided within or otherwise co-located/coupled with processing unit 720.

Secondary memory 726 may include, for example, the same or similar type of memory as primary memory and/or one or more data storage devices or systems, such as, for example, a disk drive, an optical disc drive, a tape drive, a solid state memory drive, etc. In certain implementations, secondary memory 726 may be operatively receptive of, or otherwise configurable to couple to, a computer-readable medium 740. Computer-readable medium 740 may include, for example, any medium that can carry and/or make accessible data, code and/or instructions for one or more of the devices in system 700.

Second device 704 may include, for example, a communication interface 730 that provides for or otherwise supports the operative coupling of second device 704 to at least network 708. By way of example but not limitation, communication interface 730 may include a network interface device or card, a modem, a router, a switch, a transceiver, and the like.

Second device 704 may include, for example, an input/output 732. Input/output 732 is representative of one or more devices or features that may be configurable to accept or otherwise introduce human and/or machine inputs, and/or one or more devices or features that may be configurable to deliver or otherwise provide for human and/or machine outputs. By way of example but not limitation, input/output device 732 may include an operatively configured display, speaker, keyboard, mouse, trackball, touch screen, data port, etc.

Embodiments claimed may include one or more apparatuses for performing the operations herein. These apparatuses may be specially constructed for the desired purposes, or they may comprise a general purpose computing platform selectively activated and/or reconfigured by a program stored in the device. The processes and/or displays presented herein are not inherently related to any particular computing platform and/or other apparatus. Various general purpose computing platforms may be used with programs in accordance with the teachings herein, or it may prove convenient to construct a more specialized computing platform to perform the desired method. The desired structure for a variety of these computing platforms will appear from the description below.

Embodiments claimed may include algorithms, programs and/or symbolic representations of operations on data bits or binary digital signals within a computer memory capable of performing one or more of the operations described herein. Although the scope of claimed subject matter is not limited in this respect, one embodiment may be in hardware, such as implemented to operate on a device or combination of devices, whereas another embodiment may be in software. Likewise, an embodiment may be implemented in firmware, or as any combination of hardware, software, and/or firmware, for example. These algorithmic descriptions and/or representations may include techniques used in the data processing arts to transfer the arrangement of a computing platform, such as a computer, a computing system, an electronic computing device, and/or other information handling system, to operate according to such programs, algorithms, and/or symbolic representations of operations. A program and/or process generally may be considered to be a self-consistent sequence of acts and/or operations leading to a desired result. These include physical manipulations of physical quantities. Usually, though not necessarily, these quantities take the form of electrical and/or magnetic signals capable of being stored, transferred, combined, compared, and/or otherwise manipulated. It has proven convenient at times, principally for reasons of common usage, to refer to these signals as bits, values, elements, symbols, characters, terms, numbers and/or the like. It should be understood, however, that all of these and/or similar terms are to be associated with the appropriate physical quantities and are merely convenient labels applied to these quantities. In addition, embodiments are not described with reference to any particular programming language. It will be appreciated that a variety of programming languages may be used to implement the teachings described herein.

Likewise, although the scope of claimed subject matter is not limited in this respect, one embodiment may comprise one or more articles, such as a storage medium or storage media. This storage media may have stored thereon instructions that if executed by a computing platform, such as a computer, a computing system, an electronic computing device, a cellular phone, a personal digital assistant, and/or other information handling system, for example, may result in an embodiment of a method in accordance with claimed subject matter being executed, for example. The terms “storage medium” and/or “storage media” as referred to herein relate to media capable of maintaining expressions which are perceivable by one or more machines. For example, a storage medium may comprise one or more storage devices for storing machine-readable instructions and/or information. Such storage devices may comprise any one of several media types including, but not limited to, any type of magnetic storage media, optical storage media, semiconductor storage media, disks, floppy disks, optical disks, CD-ROMs, magnetic-optical disks, read-only memories (ROMs), random access memories (RAMs), electrically programmable read-only memories (EPROMs), electrically erasable and/or programmable read-only memories (EEPROMs), flash memory, magnetic and/or optical cards, and/or any other type of media suitable for storing electronic instructions, and/or capable of being coupled to a system bus for a computing platform. However, these are merely examples of a storage medium, and the scope of claimed subject matter is not limited in this respect.

The term “instructions” as referred to herein relates to expressions which represent one or more logical operations. For example, instructions may be machine-readable by being interpretable by a machine for executing one or more operations on one or more data objects. However, this is merely an example of instructions, and the scope of claimed subject matter is not limited in this respect. In another example, instructions as referred to herein may relate to encoded commands which are executable by a processor having a command set that includes the encoded commands. Such an instruction may be encoded in the form of a machine language understood by the processor. For an embodiment, instructions may comprise run-time objects, such as, for example, Java and/or Javascript and/or PHP objects. However, these are merely examples of an instruction, and the scope of claimed subject matter is not limited in this respect.

Unless specifically stated otherwise, as apparent from the discussion herein, it is appreciated that throughout this specification discussions utilizing terms such as processing, computing, calculating, selecting, forming, enabling, inhibiting, identifying, initiating, receiving, transmitting, determining, estimating, incorporating, adjusting, modeling, displaying, sorting, applying, varying, delivering, appending, making, presenting, distorting and/or the like refer to the actions and/or processes that may be performed by a computing platform, such as a computer, a computing system, an electronic computing device, and/or other information handling system, that manipulates and/or transforms data represented as physical electronic and/or magnetic quantities and/or other physical quantities within the computing platform's processors, memories, registers, and/or other information storage, transmission, reception and/or display devices. Further, unless specifically stated otherwise, processes described herein, with reference to flow diagrams or otherwise, may also be executed and/or controlled, in whole or in part, by such a computing platform.

It should also be understood that, although particular embodiments have just been described, the claimed subject matter is not limited in scope to a particular embodiment or implementation. For example, one embodiment may be in hardware, such as implemented to operate on a device or combination of devices, for example, whereas another embodiment may be in software. Likewise, an embodiment may be implemented in firmware, or as any combination of hardware, software, and/or firmware, for example. Such software and/or firmware may be expressed as machine-readable instructions which are executable by a processor. Likewise, although the claimed subject matter is not limited in scope in this respect, one embodiment may comprise one or more articles, such as a storage medium or storage media. This storage media, such as one or more CD-ROMs and/or disks, for example, may have stored thereon instructions, that when executed by a system, such as a computer system, computing platform, or other system, for example, may result in an embodiment of a method in accordance with the claimed subject matter being executed, such as one of the embodiments previously described, for example. As one potential example, a computing platform may include one or more processing units or processors, one or more input/output devices, such as a display, a keyboard and/or a mouse, and/or one or more memories, such as static random access memory, dynamic random access memory, flash memory, and/or a hard drive, although, again, the claimed subject matter is not limited in scope to this example.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

What is claimed is:

1. A method, comprising:
receiving a selection from a user of one of a plurality of web applications;
assembling information related to one of a plurality of views of the web application to be rendered at a user computing platform and to be displayed by the user computing platform in a plurality of application areas for a respective plurality of web pages associated with the user; and
transmitting the assembled information to the user computing platform.

2. The method of claim 1, further comprising saving the selection from the user in a user application bin on a user profile page and/or at one or more specified endpoints.

3. The method of claim 1, further comprising providing a gallery of applications to the user, wherein the gallery includes information regarding the plurality of web applications, and wherein said receiving the selection from the user comprises receiving an input from the user identifying one of plurality of applications.

4. The method of claim 3, wherein said providing the gallery comprises embedding the gallery in a personalized start page for the user and/or in a profile page for the user and/or at one or more specified endpoints.

5. The method of claim 1, further comprising embedding the user application bin in a personalized start page for the user and/or in a profile page for the user and/or at one or more specified endpoints.

6. The method of claim 1, wherein said assembling information related to one of a plurality of views of the web application comprises assembling information for a small view of the selected web application to be displayed by the user computing platform.

7. The method of claim 1, wherein said assembling information related to one of a plurality of views of the web application comprises assembling information for a full view of the selected web application to be displayed by the user computing platform.

8. The method of claim 1, wherein one or more of the plurality of web pages associated with the user comprises a personalized start page.

9. The method of claim 1, wherein one or more of the plurality of web pages associated with the user comprises a profile page.

10. An apparatus, comprising:
means for receiving a selection from a user of one of a plurality of web applications;
means for assembling information related to one of a plurality of views of the web application to be rendered at a user computing platform and to be displayed by the user computing platform in a plurality of application areas for a respective plurality of web pages associated with the user; and
means for transmitting the assembled information to the user computing platform.

11. The apparatus of claim 10, further comprising means for saving the selection from the user in a user application bin on a user profile page and/or at one or more specified endpoints.

12. The apparatus of claim 10, further comprising means for providing a gallery of applications to the user, wherein the gallery includes information regarding the plurality of web applications, and wherein said means for receiving the selection from the user comprises means for receiving an input from the user identifying one of plurality of applications.

13. The apparatus of claim 12, wherein said means for providing the gallery comprises means for embedding the gallery in a personalized start page for the user and/or in a profile page for the user and/or at one or more specified endpoints.

14. The apparatus of claim 10, further comprising means for embedding the user application bin in a personalized start page for the user and/or in a profile page for the user and/or at one or more specified endpoints.

15. The apparatus of claim 10, wherein said means for assembling information related to one of a plurality of views of the web application comprises means for assembling information for a small view of the selected web application to be displayed by the user computing platform.

16. The apparatus of claim 10, wherein said means for assembling information related to one of a plurality of views of the web application comprises means for assembling information for a full view of the selected web application to be displayed by the user computing platform.

17. The apparatus of claim 10, wherein one or more of the plurality of web pages associated with the user comprises a personalized start page.

18. The apparatus of claim 10, wherein one or more of the plurality of web pages associated with the user comprises a profile page.

19. An article, comprising: a storage medium having stored thereon instructions that, if executed, enable a server computing platform to:
receive a selection from a user of one of a plurality of web applications;
assemble information related to one of a plurality of views of the web application to be rendered at a user computing platform and to be displayed by the user computing platform in a plurality of application areas for a respective plurality of web pages associated with the user; and
transmit the assembled information to the user computing platform.

20. The article of claim 19, wherein the storage medium has stored thereon further instructions that, if executed, enable the server computing platform to save the selection from the user in a user application bin on a user profile page and/or at one or more specified endpoints.

21. The article of claim 19, wherein the storage medium has stored thereon further instructions that, if executed, further enable the server computing platform to provide a gallery of applications to the user, wherein the gallery includes information regarding the plurality of web applications, and further enable the computing platform to receive the selection from the user by receiving an input from the user identifying one of plurality of applications.

22. The article of claim 21, wherein the storage medium has stored thereon further instructions that, if executed, further enable the server computing platform to provide the gallery by embedding the gallery in a personalized start page for the user and/or in a profile page for the user and/or at one or more specified endpoints.

23. The article of claim 19, wherein the storage medium has stored thereon further instructions that, if executed, further enable the server computing platform to embed the user application bin in a personalized start page for the user and/or in a profile page for the user and/or at one or more specified endpoints.

24. The article of claim 19, wherein the storage medium has stored thereon further instructions that, if executed, further enable the server computing platform to assemble information related to one of a plurality of views of the web application by assembling information for a small view of the selected web application to be displayed by the user computing platform.

25. The article of claim 19, wherein the storage medium has stored thereon further instructions that, if executed, further enable the server computing platform to assemble information related to one of a plurality of views of the web application by assembling information for a full view of the selected web application to be displayed by the user computing platform.

26. The article of claim 19, wherein one or more of the plurality of web pages associated with the user comprises a personalized start page.

27. The article of claim 19, wherein one or more of the web pages associated with the user comprises a profile page.
